(19) United States
(12) Patent Application Publication
(10) Pub. No.: US 2025/0124673 A1
(43) Pub. Date: Apr. 17, 2025

(54) PROCESSING SYSTEM, MIXED REALITY DEVICE, PROCESSING METHOD, STORAGE MEDIUM

(71) Applicant: KABUSHIKI KAISHA TOSHIBA, Tokyo (JP)

(72) Inventors: Kyotaro HAYASHI, Yokohama Kanagawa (JP); Takanori YOSHII, Kawasaki Kanagawa (JP); Hiroaki NAKAMURA, Kawasaki Kanagawa (JP); Yoshiyuki HIRAHARA, Mishima Shizuoka (JP); Takehiro KATO, Yokohama Kanagawa (JP); Yasuo NAMIOKA, Nerima Tokyo (JP)

(21) Appl. No.: 18/909,754

(22) Filed: Oct. 8, 2024

(30) Foreign Application Priority Data
Oct. 11, 2023 (JP) 2023-176061

(51) Int. Cl. G06T 19/00; G06T 7/73

(52) U.S. Cl. CPC G06T 19/006; G06T 7/73; G06T 2207/30196; G06T 2207/30204

(57) ABSTRACT

According to one embodiment, a processing system is used for a task of turning a screw at a fastening location with a tool. The processing system comprises a display device and a processing device. The display device is configured to display a virtual first object around a region where the tool can be positioned during the task. The processing device is configured to estimate a position of the tool. The processing device is configured to issue an alert in a case where the tool is determined to be in contact with the first object based on the estimated position.

### CROSS-REFERENCE TO RELATED APPLICATIONS

This application is based upon and claims the benefit of priority from Japanese Patent Application No. 2023-176061, filed on Oct. 11, 2023; the entire contents of which are incorporated herein by reference.

### FIELD

Embodiments described herein relate generally to a processing system, a mixed reality device, a processing method, and a storage medium.

### BACKGROUND

When manufacturing an article, screws may be tightened. Alternatively, screws may be loosened when an article is maintained, inspected, or repaired. For these tasks involving screws, there is a need for technology that can encourage a worker to perform these tasks more appropriately.

### BRIEF DESCRIPTION OF THE DRAWINGS

FIG. 1 is a schematic diagram illustrating a configuration of a processing system according to an embodiment;

FIG. 2 is a schematic view illustrating a mixed reality device according to the embodiment;

FIG. 3 is a schematic view illustrating a state of the real space;

FIG. 4 is a schematic view illustrating a state during a task;

FIGS. 5A and 5B are schematic views illustrating display examples by the processing system according to the embodiment;

FIG. 6 is a schematic view illustrating a display example by the processing system according to the embodiment;

FIG. 7 is a schematic view illustrating a display example by the processing system according to the embodiment;

FIG. 8 is a schematic view illustrating a display example by the processing system according to the embodiment;

FIG. 9 is a schematic view illustrating a tool;

FIG. 10 is a schematic view illustrating a display example by the processing system according to the embodiment;

FIGS. 11A to 11C are schematic views illustrating display examples by the processing system according to the embodiment;

FIGS. 12A to 12C are schematic views illustrating display examples by the processing system according to the embodiment;

FIG. 13 is a schematic view illustrating a tool;

FIG. 14 is a table illustrating changes in alerts;

FIGS. 15A and 15B are schematic views illustrating display by the processing system according to the embodiment;

FIG. 16 a schematic view illustrating a display by the processing system according to the embodiment;

FIG. 17 a schematic view illustrating a display by the processing system according to the embodiment;

FIG. 18 a schematic view illustrating a display by the processing system according to the embodiment;

FIGS. 19A and 19B are schematic views illustrating display by the processing system according to the embodiment;

FIG. 20 a schematic view illustrating a display by the processing system according to the embodiment;

FIGS. 21A and 21B are schematic views illustrating display by the processing system according to the embodiment;

FIG. 22 a schematic view illustrating a display by the processing system according to the embodiment;

FIG. 23 is a schematic view illustrating a state of the real space;

FIG. 24 is a schematic view illustrating the state of the real space;

FIG. 25 is a schematic view illustrating the state of the task;

FIG. 26 is a schematic view illustrating the state of the task;

FIG. 27 is a schematic view illustrating a display example by the processing system according to the embodiment;

FIG. 28 is a schematic view illustrating the tool;

FIG. 29A is a schematic view illustrating an example of the tool, and FIGS. 29B to 29D are schematic views illustrating an example of a marker;

FIGS. 30A to 30H are schematic views for explaining processing in the processing system according to the embodiment;

FIG. 31 is a schematic view illustrating the movement of the tool;

FIG. 32 is simultaneous equations representing the relationship between the position of each marker before movement and the position of each marker after movement;

FIG. 33 is a matrix representing the relationship between the position of the tool before movement and the position of the tool after movement;

FIG. 34 is a flowchart illustrating a processing method according to the embodiment; and

FIG. 35 is a schematic diagram illustrating a hardware configuration.

### DETAILED DESCRIPTION

According to one embodiment, a processing system is used for a task of turning a screw at a fastening location with a tool. The processing system comprises a display device and a processing device. The display device is configured to display a virtual first object around a region where the tool can be positioned during the task. The processing device is configured to estimate a position of the tool. The processing device is configured to issue an alert in a case where the tool is determined to be in contact with the first object based on the estimated position.

Embodiments of the invention will now be described with reference to the drawings.

The drawings are schematic or conceptual; and the relationships between the thicknesses and widths of portions, the proportions of sizes between portions, etc., are not necessarily the same as the actual values thereof. The dimensions and/or the proportions may be illustrated differently between the drawings, even in the case where the same portion is illustrated.

In the drawings and the specification of the application, components similar to those described therein above are marked with like reference numerals, and a detailed description is omitted as appropriate.

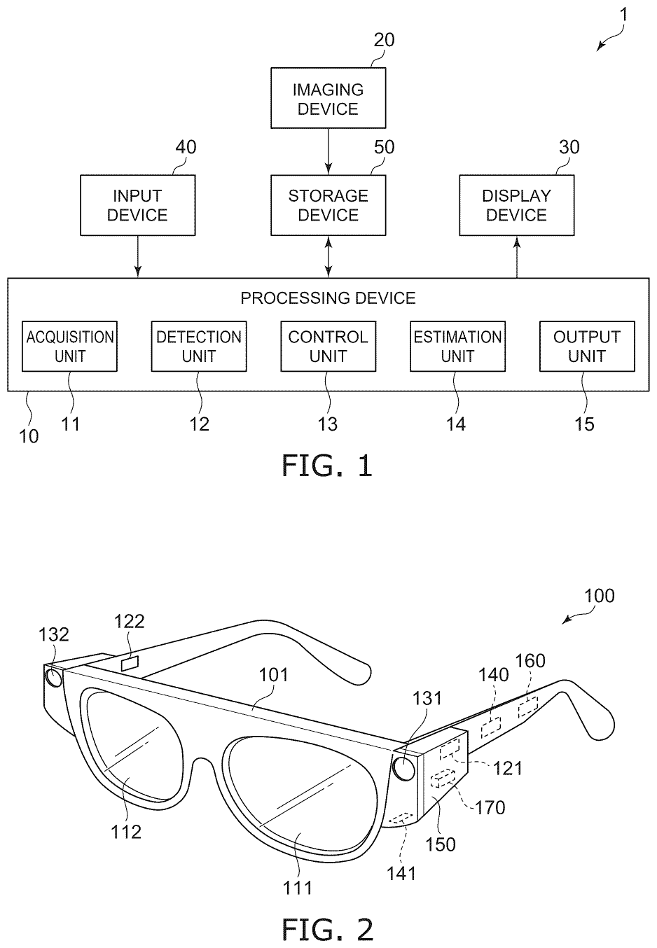

FIG. 1 is a schematic diagram illustrating a configuration of a processing system according to an embodiment.

An invention according to the embodiment is applicable to a task of turning a screw using a tool. As shown in FIG. 1, the processing system 1 includes a processing device 10, an imaging device 20, a display device 30, an input device 40, and a storage device 50.

The imaging device 20 images the appearance of a task. For example, fasteners such as screws are tightened into an article using a tool during the task. Alternatively, the screws tightened into the article are loosened using a tool. The article is a part for manufacturing a product, a unit, or a semi-finished product. The tool is a wrench or a screwdriver. Here, mainly an example in which an embodiment of the present invention is applied to a fastening task of tightening screws will be described.

When assembling an article, the worker holds the tool in their hand and tightens the screws. The imaging device 20 images the tool, the worker's hand, and other relevant items. For example, the imaging device 20 includes a camera that acquires an RGB image and a depth image.

The processing device 10 receives continuous images (video) imaged by the imaging device 20. The processing device 10 detects the left or right hand in the images. Hand tracking technology is used for the detection of the left or right hand. Hereinafter, when there is no particular distinction between the left hand and the right hand, at least one of the left hand and the right hand is simply referred to as “the hand”.

The input device 40 is used by the worker to input information to the processing device 10. The input device 40 includes a microphone. The worker can input information to the processing device 10 by speaking into the input device 40. For example, a voice corresponding to a voice command is input into the input device 40. Besides the input device 40, the worker can input information to the processing device 10 through hand gestures or other means.

The processing device 10 causes the display device 30 to display information to support the fastening task. The display device 30 displays information to the worker. For example, the processing device 10 displays a hand detection result, a virtual object indicating a region where the tool should not enter, the task instruction, etc. during the fastening task.

The storage device 50 stores data necessary for the processing of the processing device 10, data obtained by the processing of the processing device 10, and the like. For example, the storage device 50 contains data related to the task, data necessary for estimating the position of the tool described later, etc.

The processing device 10 determines whether an inappropriate task is being performed during the fastening task. Specifically, the display device 30 displays a virtual first object indicating a region where the tool should not enter during the fastening task. The first object is displayed around the region where the tool can be positioned in the fastening task. During the display of the first object, the processing device 10 estimates the position of the tool. The processing device 10 determines whether or not the tool is in contact with the first object based on the estimated position of the tool. In a case where it is determined that the tool is in contact with the first object, the processing device 10 issues an alert.

According to this process, the alert can be issued if the tool is in an inappropriate orientation, if the screw is tightened into a wrong fastening location, or the like. The alert can notify the worker that an inappropriate task is being performed.

Specifically, as shown in FIG. 1, the processing device 10 has functions as an acquisition unit 11, a detection unit 12, a control unit 13, an estimation unit 14, and an output unit 15. The acquisition unit 11 acquires images imaged by the imaging device 20, data input by the input device 40, etc. in real time.

The detection unit 12 detects the user's hand appearing in the image. The detection unit 12 measures the three-dimensional position of each point of the detected hand. More specifically, the hand includes multiple joints, such as DIP joints, PIP joints, MP joints, CM joints, and so on. The position of any of these joints is used as the position of the hand. The position of the center of gravity of the multiple joints may be used as the position of the hand. Alternatively, the overall center position of the hand may be used as the position of the hand.

The detection unit 12 repeats hand detection on the continuously acquired images and performs hand tracking. In addition, the detection unit 12 detects a hand gesture from a time-series change in the position of the detected hand. For example, the detection unit 12 calculates the similarity between the change in the position of the hand and a hand movement of each predefined hand gesture. For any hand gesture, if the similarity exceeds a preset threshold, the detection unit 12 determines that the user's hand is moving to indicate the hand gesture.

When voice data is acquired by the acquisition unit 11, the detection unit 12 detects a voice command from the voice. For example, the detection unit 12 performs speech recognition and converts the user's spoken content into a character string. The detection unit 12 determines whether or not the spoken content includes any predefined voice command string. When the spoken content includes a string of any voice command, the detection unit 12 determines that the user is speaking the voice command.

In addition to hand detection or command detection, the detection unit 12 performs processing such as detecting a marker appearing in the image, measuring the three-dimensional position of the marker, and detecting contact with an object in virtual space. The control unit 13 performs various processes and controls based on the information detected by the detection unit 12. The estimation unit 14 estimates the position of the tool during the fastening task. The output unit 15 outputs a video signal to the display device 30. The video signal indicates the detection result by the detection unit 12, the data obtained by the processing of the control unit 13, etc. The display device 30 displays information based on the input video signal.

Hereinafter, outputting of the video signal from the processing device 10 to the display device 30 and displaying of information by the display device 30 based on the video signal, are simply referred to as “the processing device 10 (or the display device 30) displays the information”.

Hereinafter, details of the invention according to the embodiment will be described with reference to specific examples. Here, an example in which the processing system 1 is implemented as an MR device will be described. In the MR devices, the virtual space is displayed overlaid on the real space. The user can interact with objects displayed in the virtual space.

FIG. 2 is a schematic view illustrating a mixed reality device according to the embodiment.

The processing system 1 shown in FIG. 1 is realized, for example, as a mixed reality (MR) device. The MR device 100 shown in FIG. 2 includes a frame 101, a lens 111, a lens 112, a projection device 121, a projection device 122, an image camera 131, a depth camera 132, a sensor 140, a microphone 141, a processing device 150, a battery 160, and a storage device 170.

The processing device 150 is an example of the processing device 10. The image camera 131 and the depth camera 132 are examples of the imaging device 20. The projection device 121 and the projection device 122 are examples of the display device 30. The microphone 141 is an example of the input device 40. The storage device 170 is an example of the storage device 50.

In the illustrated example, the MR device 100 is a binocular-type head-mounted display. Two lenses 111 and 112 are embedded in the frame 101. The projection devices 121 and 122 project information onto lenses 111 and 112, respectively.

The projection device 121 and the projection device 122 display the detection result of the worker's body, a virtual object, etc. on the lens 111 and the lens 112. Only one of the projection device 121 and the projection device 122 may be provided, and information may be displayed on only one of the lens 111 and the lens 112.

The lens 111 and the lens 112 are transparent. The worker can see the real-space environment through the lens 111 and the lens 112. The worker can also see the information projected onto the lens 111 and the lens 112 by the projection device 121 and the projection device 122. The projections by the projection device 121 and the projection device 122 display information overlaid on the real space.

The image camera 131 detects visible light and acquires a two-dimensional image. The depth camera 132 emits infrared light and acquires a depth image based on the reflected infrared light. The sensor 140 is a 6-axis detection sensor, and can detect 3-axis angular velocity and 3-axis acceleration. The microphone 141 accepts voice input.

The processing device 150 controls each element of the MR device 100. For example, the processing device 150 controls the display by the projection device 121 and the projection device 122. The processing device 150 detects the movement of the field of view based on the detection result by the sensor 140. The processing device 150 changes the display by the projection device 121 and the projection device 122 in response to the movement of the field of view. In addition, the processing device 150 can perform various processes using data obtained from the image camera 131 and the depth camera 132, the data of the storage device 170, etc.

The battery 160 supplies the power necessary for operation to each element of the MR device 100. The storage device 170 stores data necessary for the processing of the processing device 150, data obtained by the processing of the processing device 150, etc. The storage device 170 may be provided outside the MR device 100 and may communicate with the processing device 150.

Not limited to the illustrated example, the MR device according to the embodiment may be a monocular-type head mounted display. The MR device may be a glasses-type as illustrated, or may be a helmet type.

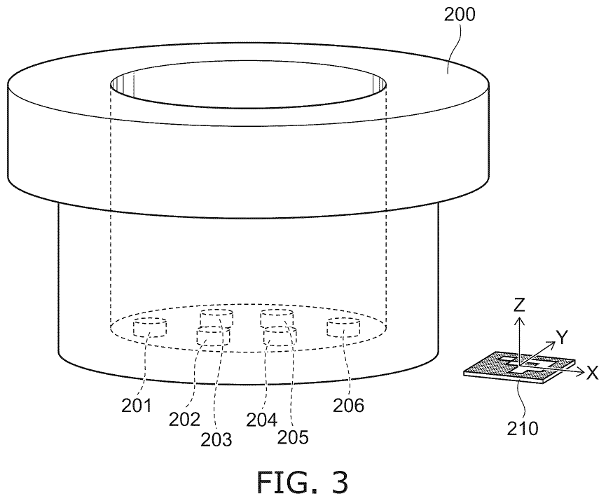

FIG. 3 is a schematic view illustrating a state of the real space.

For example, there is an article 200 shown in FIG. 3 in the real space. Article 200 is a cylindrical member. The inside of the article 200 is a cavity, and there are fastening locations 201 to 206 at the bottom of the cavity. In this example, a screw fastening task is performed on the article 200. In the fastening task, a screw is tightened into each of the fastening locations 201 to 206 using a wrench and an extension bar. The MR device is used to support this fastening task. For example, virtual objects indicate the appropriate orientation of the tool, the fastening position, the position where the hand is placed when fastening, etc.

A marker 210 is provided in the vicinity of the article 200 to be worked. In the illustrated example, the marker 210 is an augmented reality (AR) marker. As will be described later, the marker 210 is provided for setting an origin of the three-dimensional coordinate system. Instead of the AR marker, a one-dimensional code (barcode), a two-dimensional code (QR code (registered trademark)), or the like may be used as the marker 210. Alternatively, instead of a marker, the origin may be indicated by a hand gesture. The processing device 10 sets a three-dimensional coordinate system of the virtual space based on multiple points indicated by the hand gesture.

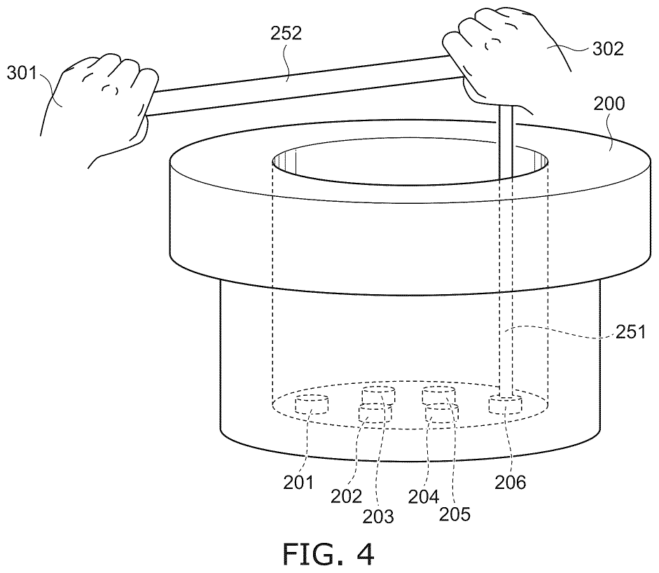

FIG. 4 is a schematic view illustrating a state during the task. When a screw is tightened into the article 200, the worker places the screw at one of the fastening locations. The worker inserts one end of the extension bar 251 into the screw. The worker fits the wrench 252 at the other end of the extension bar 251. As shown in FIG. 4, the worker holds both ends of the wrench 252 with both hands. In this state, the worker tightens the screw into the fastening location by turning the wrench 252 and rotating the extension bar 251.

When the fastening task is performed, it is preferable for the tool to be used in an appropriate orientation. If the tool is used in an inappropriate orientation, it may damage the article. There is also a risk of injury to the worker. Further, depending on the fastening task, the order of fastening of screws to multiple fastening locations may be defined, or the screws may be tightened only at specific fastening locations. In these cases, it is necessary to tighten the screws into the appropriate locations.

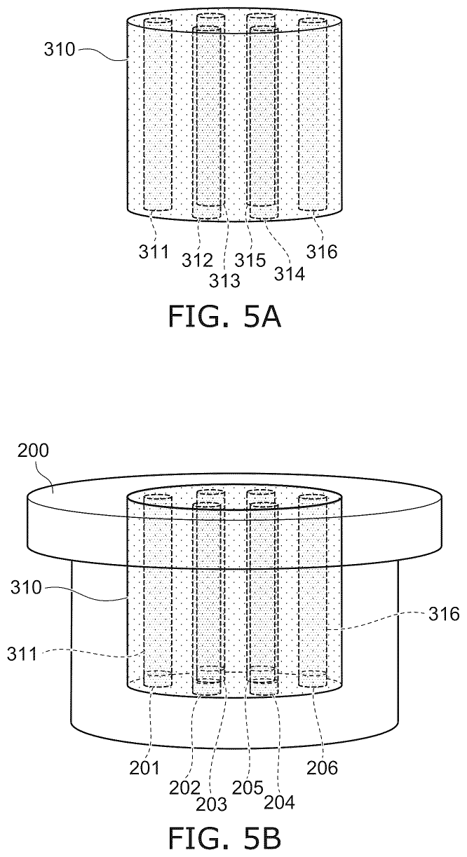

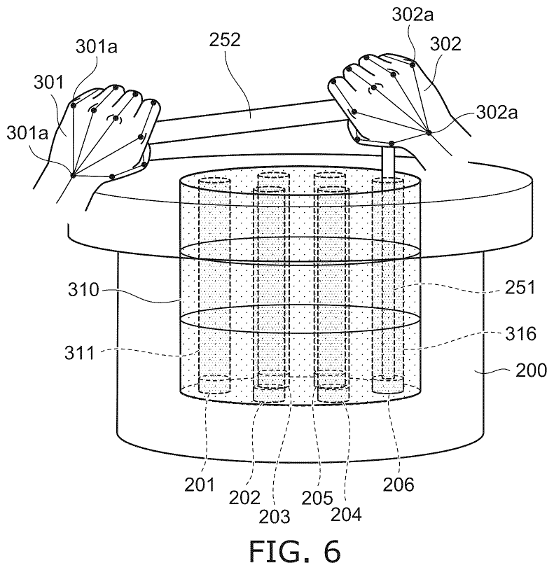

FIG. 5A, FIG. 5B, and FIG. 6 to FIG. 8 are schematic views illustrating display examples by the processing system according to the embodiment.

The processing device 10 displays a virtual first object 310 shown in FIG. 5A to facilitate an appropriate fastening task. The first object 310 has a cylindrical shape following the inner shape of the article 200. As shown in FIG. 5B, the first object 310 is displayed overlaid on the article 200 in the real space and is located inside the article 200. The shape and size of the first object 310 are set according to the shape and size of the article 200.

In the illustrated example, the first object 310 is provided with multiple holes 311 to 316. The holes 311 to 316 are formed in a region where the tool can be located when the screw is tightened into the fastening locations 201 to 206. The position and number of holes are set according to the position and number of fastening locations on the article 200. The first object 310 is positioned around the holes 311 to 316, which indicate regions where the tool can be positioned.

The shape, diameter, etc. of the holes 311 to 316 are set according to the tool used. In the illustrated example, an extension bar 251 is used. Consequently, the shape of holes 311 to 316 is linear, matching the shape of the extension bar 251. The holes 311 to 316 extend in the vertical direction. The diameter of the holes 311 to 316 is determined by adding a margin to the diameter of the extension bar 251.

During the fastening task, the article 200, the left hand of the worker, and the right hand of the worker are imaged by the imaging device 20. The processing device 10 (the acquisition unit 11) acquires the captured image. The processing device 10 (the detection unit 12) detects the left hand and the right hand from the acquired image. The processing device 10 (the control unit 13) causes the display device 30 to display the hand detection result. For example, as shown in FIG. 6, the processing device 10 (the output unit 15) overlays the detection result of the left hand 301 and the detection result of the right hand 302 onto the hands in the real space. In the example shown in FIG. 6, multiple objects 301a and multiple objects 302a are displayed as detection results of the left hand 301 and the right hand 302. The multiple objects 301a respectively represent multiple joints of the left hand 301. The multiple objects 302a respectively represent multiple joints of the right hand 302. Instead of joints, objects respectively representing the surface shape of the left hand 301 and the surface shape of the right hand 302 may be displayed.

When the extension bar 251 and wrench 252 are used in an appropriate orientation, the extension bar 251 passes through the inside of the hole, as shown in FIG. 6. In other words, the extension bar 251 does not come into contact with the first object 310.

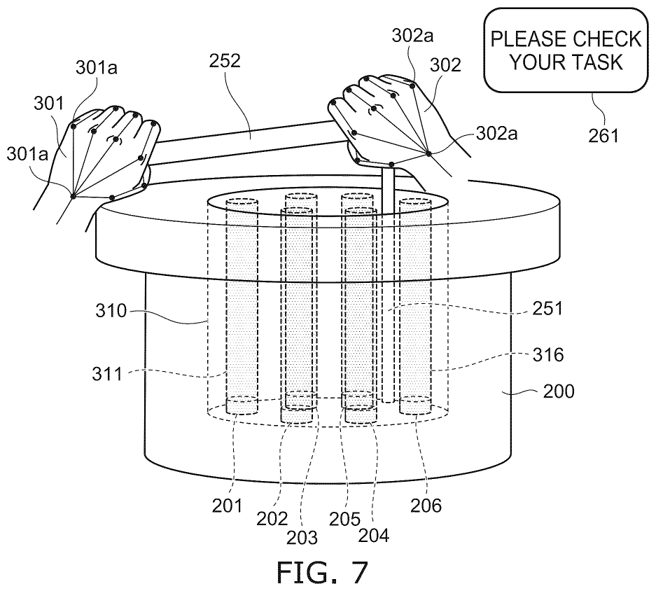

If the extension bar 251 or wrench 252 is used in an inappropriate orientation, the extension bar 251 deviates from the hole and comes into contact with the first object 310, as shown in FIG. 7. The processing device 10 issues an alert when the tool comes into contact with the first object 310. In this example, message 261 is displayed as an alert. Instead of a message, a warning color may be displayed. Instead of a display, a sound, vibration, light, or the like may be issued as an alert. Alternatively, an alert that combines two or more selected from display, sound, vibration, and light may be used.

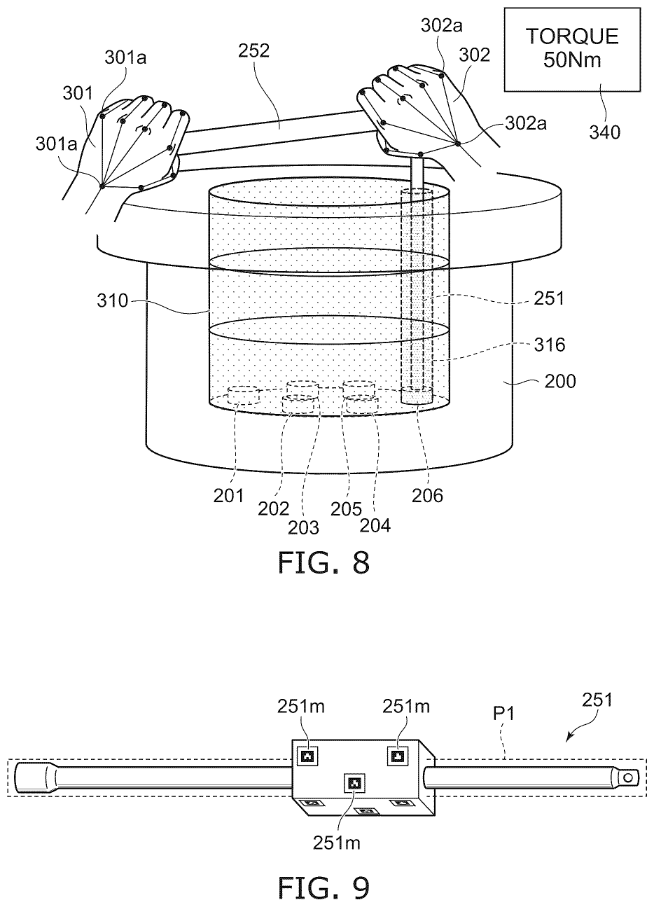

When the screw is tightened only at a specific fastening location, the hole is provided only at the position corresponding to that fastening location. For example, it is defined that a screw is first tightened into the fastening location 206 out of the fastening locations 201 to 206. In such a case, as shown in FIG. 8, only the hole 316 corresponding to the fastening location 206 is provided. The first object 310 is displayed over the region of holes 311 to 315. When the screw is supposed to be tightened into the fastening location 206 but is mistakenly tightened into a different fastening location, the extension bar 251 comes into contact with the first object 310. As a result, the processing device 10 issues an alert

Various methods can be used to estimate the position of the tool. For example, the position of the fastening locations 201 to 206 is registered in advance. During the fastening task, the worker's hand is detected by the processing device 10. When the extension bar 251 is used, one end of the extension bar 251 is held by hand as shown in FIG. 4. In addition, in the fastening task, the extension bar 251 is generally used to be parallel to the vertical or horizontal direction. The processing device 10 (estimation unit 14) estimates that the extension bar 251 exists in the region between the position of the hand and the fastening location aligned with the hand in the vertical or horizontal direction. The processing device 10 uses the position of the region as the position of the tool.

Or, a sensor may be provided on the extension bar 251 or wrench 252, and the position of the extension bar 251 may be estimated using the sensor's detection values. Sensors may be an inclination sensor, an acceleration sensor, a gyro sensor, or similar. The position of the extension bar 251 may be estimated by combining the sensor's detection value with the detection result of the hand. For example, when the extension bar 251 is not parallel to the vertical direction or horizontal direction, the position of the extension bar 251 can be estimated more accurately.

Alternatively, the processing device 10 may estimate the position of the extension bar 251 or wrench 252 by image processing. For example, an image (template image) of the tool to be used is prepared in advance. The processing device 10 performs template matching and determines whether the tool in the template image appears in the image obtained during the task. The processing device 10 uses a position where the tool of the template image is determined to be appeared as the position of the tool.

FIG. 9 is a schematic view illustrating a tool.

As shown in FIG. 9, multiple markers 251m for estimating the position of the extension bar 251 may be attached to the extension bar 251. The processing device 10 detects multiple markers 251m from the image. The processing device 10 measures the position of each marker 251m. The positional relationship between the multiple markers 251m and the extension bar 251 is registered in advance. Based on the positional relationship, the processing device 10 calculates the position P1 of the extension bar 251 from the position of each marker 251m.

Advantages of the embodiment will now be described.

When turning a screw, it is required to perform the task appropriately. In other words, it is required to use the tool in an appropriate orientation, tighten the screw into an appropriate location, or loosen the screw at an appropriate location, etc. According to the invention of the embodiment, the virtual first object 310 is displayed during the task. The first object 310 is displayed around the region where the tool can be positioned in the task. In other words, the first object 310 indicates a region where the tool should not be located so that the tool is used in an appropriate orientation or to turn the screw at the correct location.

In addition, the position of the tool is estimated during the display of the first object 310, If the tool is determined to be in contact with the first object 310, an alert is issued. Contact of the tool to the first object 310 means that the tool is being used in an inappropriate orientation or that the screw at the wrong location is being turned. When the tool comes into contact with the first object 310, an alert is issued, which informs the worker that an inappropriate task is being performed.

According to the embodiment, it is possible to encourage the worker to perform the task more appropriately. For example, the possibility of the tool being used in an inappropriate orientation, which could lead to damage to the article or injury to the worker, can be reduced. Alternatively, it is possible to suppress the screw from being turned into the wrong location.

Hereinafter, a more preferred example of the invention according to the embodiment will be described.

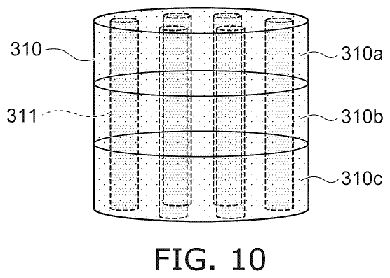

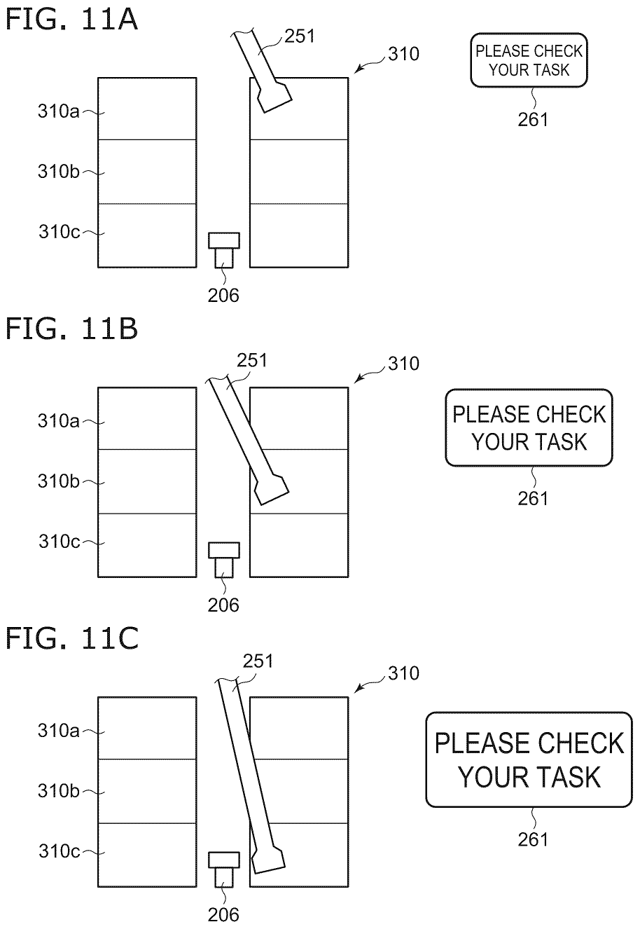

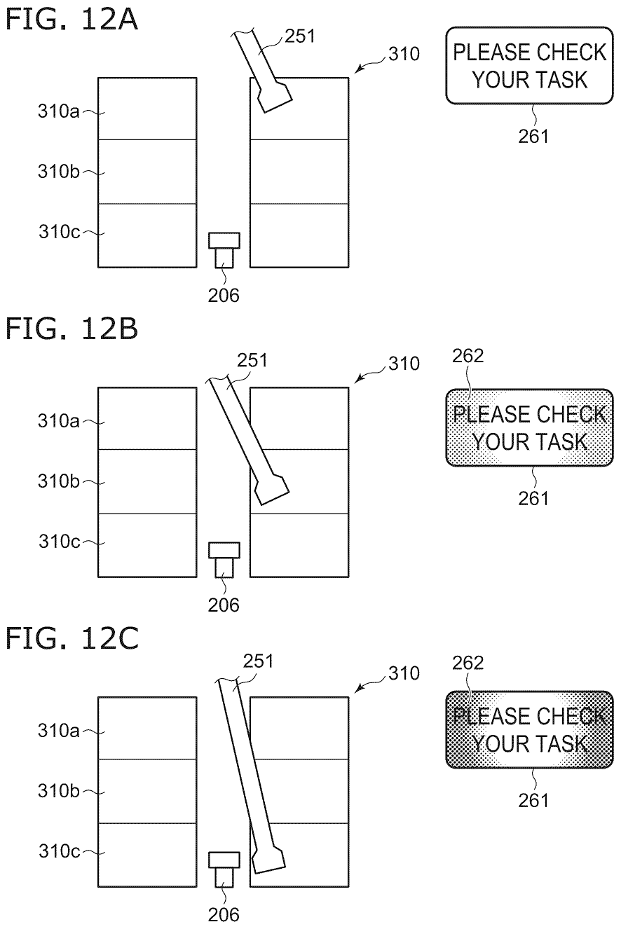

FIG. 10, FIGS. 11A to 11C, and FIGS. 12A to 12C are schematic views illustrating display examples by the processing system according to the embodiment.

Different functions may be assigned to each portion of the first object 310. For example, as shown in FIG. 10, the first object 310 includes a first region 310a, a second region 310b, and a third region 310c. The second region 310b is positioned between the first region 310a and the fastening location. The third region 310c is positioned between the second region 310b and the fastening location. That is, the second region 310b is located closer to the fastening location than the first region 310a and is farther away from the fastening location compared to the third region 310c.

The processing device 10 differentiates the alert triggered when the tool comes into contact with the first region 310a, the alert triggered when the tool comes into contact with the second region 310b, and the alert triggered when the tool comes into contact with the third region 310c from each other. For example, the alert triggered when the tool comes into contact with the second region 310b is stronger than the alert triggered when the tool comes into contact with the first region 310a, and weaker than the alert triggered when the tool comes into contact with the third region 310c.

As an example, as shown in FIGS. 11A to 11C, the message 261 displayed when the tool comes into contact with the second region 310b is larger than the message 261 displayed when the tool comes into contact with the first region 310a, and smaller than the message 261 displayed when the tool comes into contact with the third region 310c. As another example, when the tool comes into contact with the first region 310a, only the message 261 is displayed as shown in FIG. 12A. When the tool comes into contact with the second region 310b, in addition to the message 261, a warning color 262 is displayed as shown in FIG. 12B. When the tool comes into contact with the third region 310c, in addition to the message 261, a stronger warning color 262 is displayed as shown in FIG. 12C. The warning color 262 may be displayed in a portion of the field of view in addition to the message 261.

If the tool comes into contact with the first object 310 at a position farther away from the fastening location, it is less likely that an inappropriate fastening task will be performed than if the tool comes into contact with the first object 310 at a position closer to the fastening location. In addition, at a position far from the fastening location, the worker may move the tool in order to readjust the tool, align the tool, etc. If a strong alert is issued at a position far from the fastening location, it will cause stress to the worker. By varying the alert triggered when the tool comes into contact with the first object 310 depending on the distance from the fastening location, a more appropriate alert can be issued.

Instead of one first object 310, a first object having a function as the first region 310a, a second object having a function as the second region 310b, and a third object having a function as the third region 310c may be provided. In such a case, it can be considered that the first object 310 including the first to third regions 310a to 310c is provided. Further, the number of regions set in the first object 310 is optional. The number of regions to be set may be two or more than three.

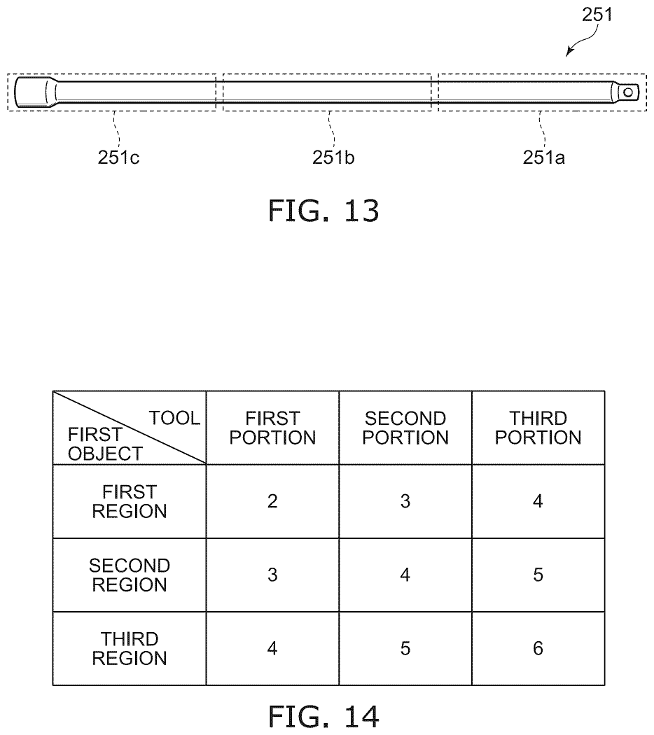

FIG. 13 is a schematic view illustrating a tool. Instead of setting the region on the first object 310, the alert may change depending on a position of the tool in contact with the first object 310. For example, when the position of the extension bar 251 is estimated, the processing device 10 sets a first portion 251a, a second portion 251b, and a third portion 251c to the extension bar 251 as shown in FIG. 13. When the extension bar 251 is used, the second portion 251b is positioned between the fastening location and the first portion 251a. The third portion 251c is positioned between the fastening location and the second portion 251b.

The processing device 10 differentiates the alert triggered when the first portion 251a comes into contact with the first object 310, the alert triggered when the second portion 251b comes into contact with the first object 310, and the alert triggered when the second portion 251c comes into contact with the first object 310 from each other. For example, the alert triggered when the second portion 251b comes into contact with the first object 310 is stronger than the alert triggered when the third portion 251c comes into contact with the first object 310, and weaker than the alert triggered when the first portion 251a comes into contact with the first object 310. In other words, the closer the portion to the grip comes into contact with the first object 310, the stronger the alert is issued. By varying the alerts depending on the portion of the tool that comes into contact with the first object 310, more appropriate alerts can be issued. The number of portions set on the extension bar 251 is optional. The number of portions may be two or more than three.

FIG. 14 is a table illustrating changes in alerts.

The setting of the region to the first object 310 and the setting of the portion to the tool may be combined. For example, as shown in FIG. 10, the first region 310a to the third region 310c are set to the first object 310, and as shown in FIG. 13, the first portion 251a to the third portion 251c are set to the extension bar 251. In such a case, as shown in FIG. 14, the alert can be changed depending on the combination of the portion of the tool in contact with the region of the first object 310. In the example shown in FIG. 14, the numerical value described in the cell indicates the strength of the alert. Specifically, the closer the tool grip comes into contact with the first object 310 and the closer the tool comes into contact with the first object 310 to the fastening location, the stronger the alert is issued.

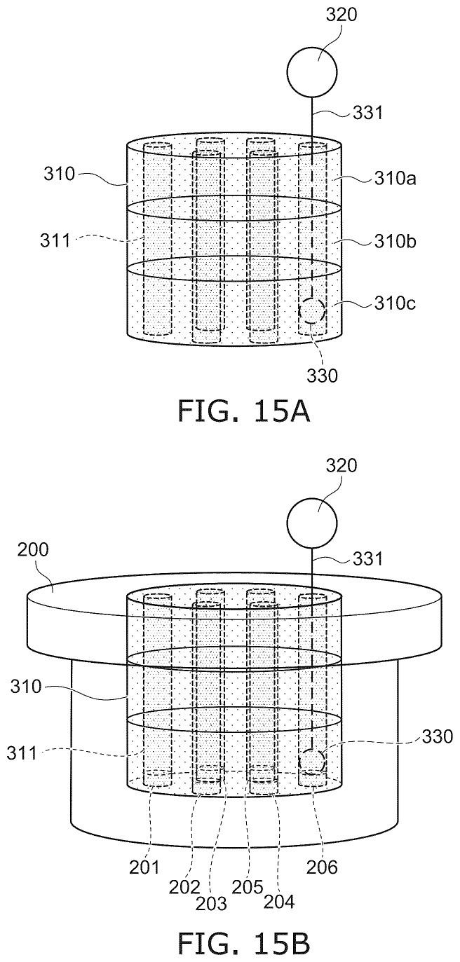

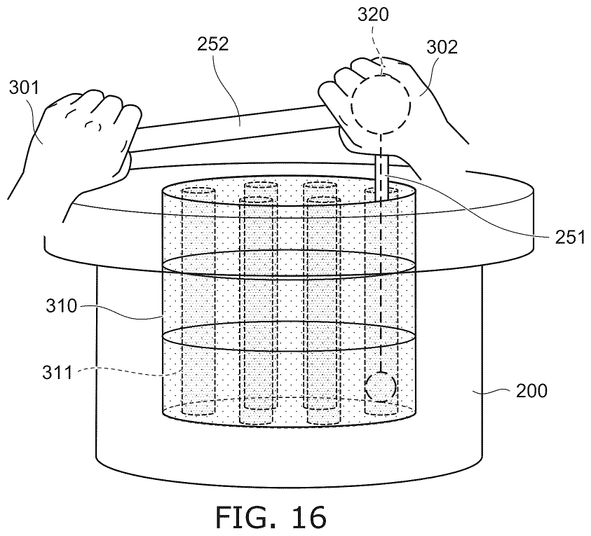

FIG. 15A, FIG. 15B, FIGS. 16 to 18, FIG. 19A, FIG. 19B, FIG. 20, FIG. 21A, FIG. 21B, and FIG. 22 are schematic views illustrating display by the processing system according to the embodiment.

As shown in FIG. 15A, in addition to the first object 310, a virtual second object 320 may be displayed. In this example, the second object 320 is displayed at a position away from the fastening location. As shown in FIG. 15B, one of the holes formed on the first object 310 is positioned between the fastening location and the second object 320. The second object 320 indicates the region where the worker's hand or tool should be positioned during the fastening task.

In the examples shown in FIGS. 15A and 15B, the second object 320 is spherical and is displayed distinguishably from the first object 310. As illustrated, in addition to the second object 320, virtual objects 330 and 331 may be displayed. The object 330 is spherical and is displayed overlapping the fastening location. The object 331 is linear and connects the second object 320 and the object 330. In this example, the second object 320 indicates the region where the tip of the wrench 252 or the hand should be positioned. The object 330 indicates the fastening location of the screw. The object 331 indicates the region where the extension bar should be positioned.

The processing device 10 may detect that a prescribed physical object has come into contact with the second object 320. For example, the processing device 10 detects that the hand has come into contact with the second object 320. Specifically, the processing device 10 calculates the distance between the position of the hand and the second object 320. When the distance is less than a preset threshold, the processing device 10 determines that the hand has come into contact with the virtual object. As an example, in FIG. 15B, the diameter of the second object 320 corresponds to a threshold value. The sphere indicates the range where the hand is determined to be in contact with the virtual object.

Alternatively, the processing device 10 may estimate the position of the wrench 252. The processing device 10 detects that the wrench 252 has come into contact with the second object 320 using the distance between the wrench 252 and the second object 320. Various methods can be used to estimate the position of the wrench 252, as well as the estimation of the position of the extension bar 251. For example, as shown in FIG. 4, during the fastening task, both ends of the wrench 252 are held by the hands. The processing device 10 can estimate the position of the wrench 252 from the positions of the both hands. Similar to the extension bar 251 shown in FIG. 9, multiple markers for estimating the position of the wrench 252 may be attached to the wrench 252.

By displaying the second object 320, the worker can easily grasp where to position the hand or tool to perform the fastening task. In particular, when a screw is tightened into an article with a large number of fastening locations, or when a screw is tightened into an article with fastening locations that are difficult to see, the worker can perform the fastening task more smoothly by displaying the second object 320.

During performing the fastening task, the hand or tool comes into contact with the second object 320 as shown in FIG. 16. Corresponding to one fastening location, one second object 320 is displayed. When the hand or tool comes into contact with the second object 320, it can be estimated (inferred) that the screw is turned into the fastening location corresponding to the second object 320. Hereafter, among the one or more fastening locations, the fastening location where a screw is estimated to be turned will be referred to as the “estimated location.”

If the location where the screw is turned can be estimated, it is possible to automatically generate the task record indicating at which location the screw was turned. When the worker completes the task of turning the screw, the processing device 10 records that the screw has been turned at the estimated location.

Preferably, a digital tool is used in the task. The processing device 10 receives the detection value from the digital tool. The processing device 10 can determine whether screw-tightening at the estimated location has been completed using the detection value. When it is determined that screw-tightening has been completed, the processing device 10 inputs the task result into the task record. According to this method, it is possible to automatically generate the task record more accurately.

For example, the digital tool is a digital torque wrench or a digital torque screwdriver. The detection value is a torque value detected by the digital tool. The digital torque wrench or digital torque screwdriver detects the torque value and transmits it to the processing device 10. When the torque value exceeds a predetermined threshold, the processing device 10 determines that the screw-tightening has been completed. The digital tool may determine whether or not the torque value exceeding a predetermined threshold value has been detected. In such a case, the digital tool may output the determination result as the detection value instead of the torque value. The digital tool may output both the determination result and the torque value. Additionally, the digital tool may detect the rotation angle when the screw is turned, or other relevant parameters. The processing device 10 may associate the received detection value with the data related to the estimated location.

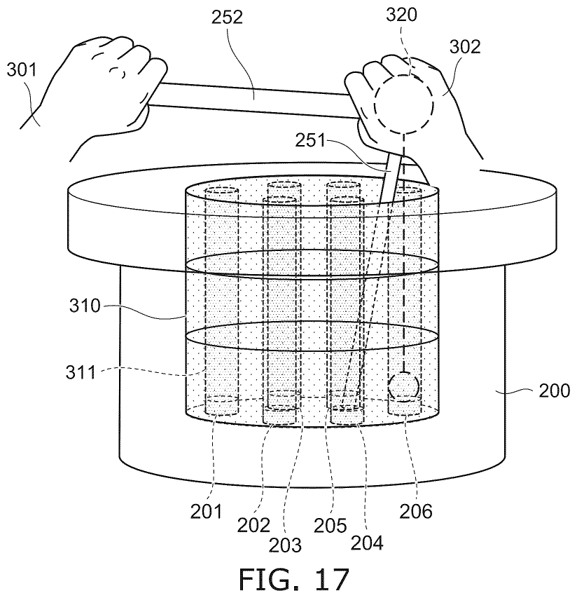

If the tool comes into contact with the first object 310 after the prescribed physical object comes into contact with the second object 320, the processing device 10 disassociates the data related to the estimated location. If the tool comes into contact with the first object 310, the tool may be used in the incorrect orientation as shown in FIG. 17, and the screw may be tightened into a location different from the estimated location. If the detection value is associated with the data related to the estimated location despite the tool coming into contact with the first object 310, there is a possibility that an incorrect task record will be created.

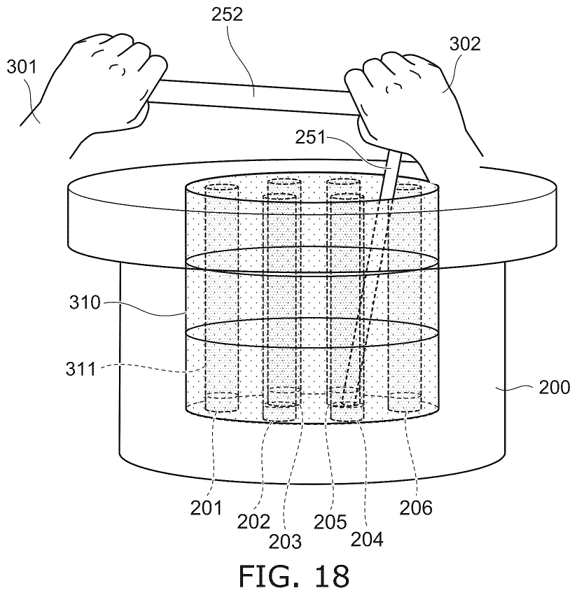

As shown in FIG. 18, the processing device 10 may stop displaying the second object 320 if a prescribed physical object comes into contact with the second object 320 and then the tool comes into contact with the first object 310. This process makes it easier for the worker to recognize that an inappropriate task is being performed. Subsequently, if the tool is no longer detected as being in contact with the first object 310, the processing device 10 will display the second object 320 again.

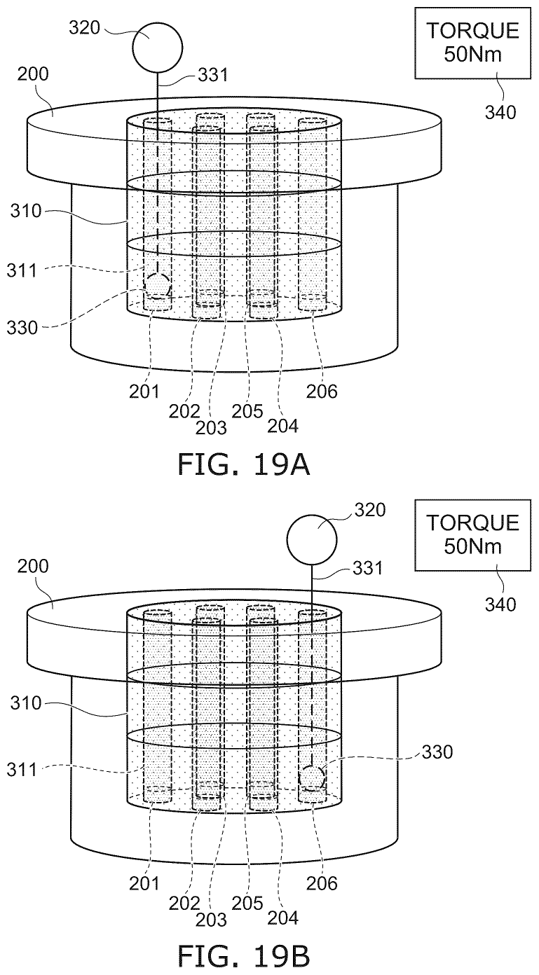

The order of tightening of the screws may be determined depending on the article. Virtual objects may be used to indicate the order. For example, in one state, one second object 320 is displayed above only one of the fastening locations 201 to 206, as shown in FIG. 19A. In another state, the second object 320 is displayed above only another one of the fastening locations 201 to 206, as shown in FIG. 19B.

As shown in FIGS. 19A and 19B, an object 340 (a third object) indicating instructions for the fastening task may be further displayed. In the illustrated example, the torque value required for screw-tightening of the fastening location is displayed on the object 340.

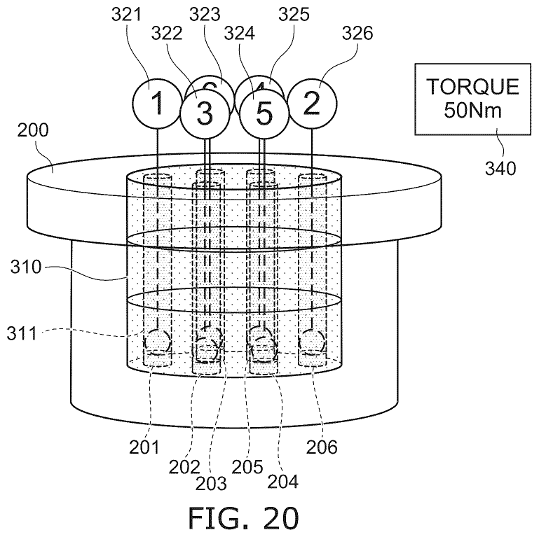

As shown in FIG. 20, the second objects 321 to 326 may be respectively displayed corresponding to the fastening locations 201 to 206, and information indicating the order of fastening may be displayed on the second objects 321 to 326. By indicating the order of fastening by the objects, the worker can perform the fastening task more smoothly. It is possible to suppress the occurrence of errors in the order of fastening.

The screw may be tightened multiple times at one location. For example, after screws are respectively tightened into the fastening locations 201 to 206, each screw may be retightened. In such a case, the number of times each screw has been tightened for each fastening location may be indicated by the object.

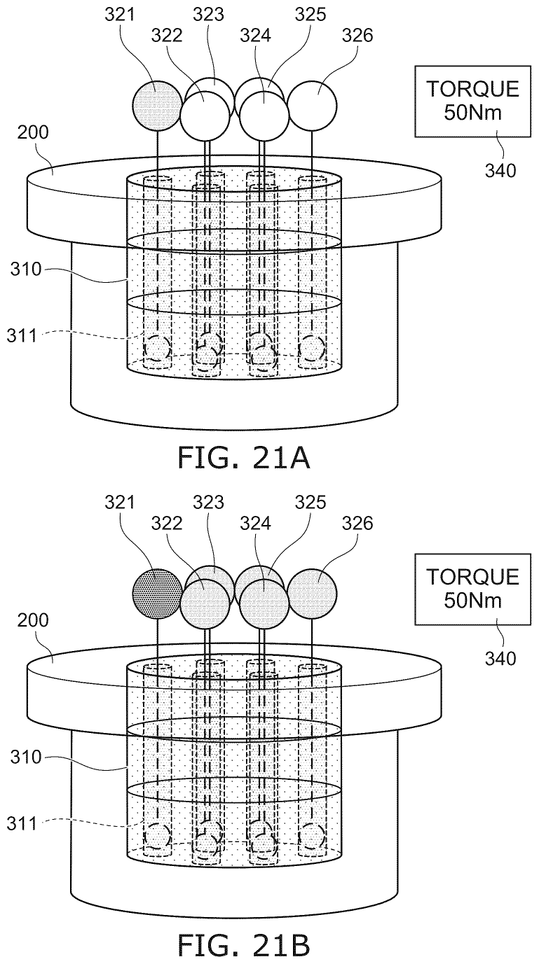

In the example shown in FIG. 21A, the second objects 321 to 326 are displayed at the fastening locations 201 to 206, respectively. A screw is tightened only into the fastening location 201, and a screw is not tightened into the fastening locations 202 to 206. At this time, the color of the second object 321 is different from the color of the second objects 322 to 326. Instead of color, the size, pattern, shape, etc. of the object may be different.

In the example shown in FIG. 21B, a screw is tightened into the fastening locations 201 to 206, and only the screw at the fastening locations 201 is retightened. At this time, the color of the second object 321 is different from the color of the second objects 322 to 326. In addition, the color of the second object 321 after the screw is retightened, shown in FIG. 21B, is different from the color of the second object 321 before the screw is retightened, shown in FIG. 21A.

As shown in FIGS. 20, 21A, and 21B, the display form of the second objects 321 to 326 may be different from each other depending on the fastening order of the fastening locations or whether or not each of the fastening locations has been fastened. This allows the worker to perform the fastening task more smoothly.

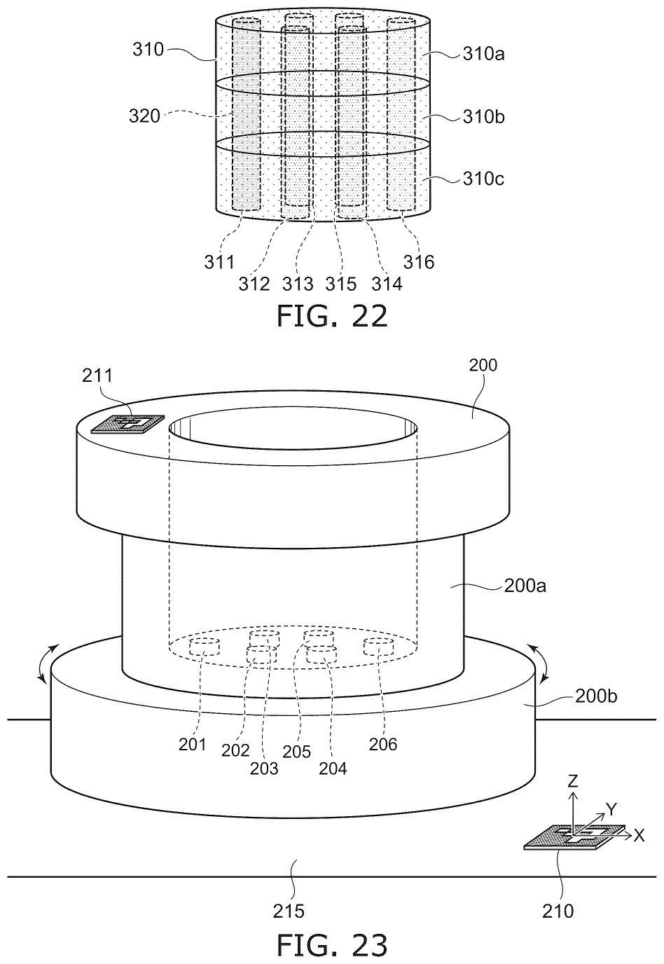

As shown in FIG. 22, the second object 320 may be displayed inside the hole of the first object 310. According to this display method, the worker can easily check visually which area within the first object 310 to pass the tool through. In such a case, the processing device 10 detects contact between the extension bar 251 and the second object 320. When it is determined that the extension bar 251 is in contact with the second object 320, it is estimated that a screw is tightened into the location corresponding to the second object 320.

Each of the above-described virtual objects is displayed according to the position of objects in the real space. For example, the three-dimensional coordinate system of the virtual space when the virtual objects are prepared is set to be the same as the three-dimensional coordinate system of the virtual space when the fastening task is performed. In addition, the positional relationship between the origin of the three-dimensional coordinate system and task objects when the virtual objects are prepared is set to be the same as the positional relationship between the origin of the three-dimensional coordinate system and the task objects when the fastening task is performed.

In order to facilitate these settings, as shown in FIG. 3, it is preferable that the marker 210 for setting the origin is prepared in the real space. When the virtual objects are prepared, the three-dimensional coordinate system is set with the marker 210 as the origin. When the fastening task is performed, the processing device 10 detects the marker 210 from the image and sets the three-dimensional coordinate system based on the marker 210. The display position of each virtual object is determined with reference to the marker 210. As long as the positional relationship between the marker 210 and the article to be worked on remains unchanged, it is possible to display the prepared objects according to the article during the fastening task.

FIG. 23 is a schematic view illustrating a state of the real space.

There is a case where the fastening location may move with respect to the marker 210. In the example shown in FIG. 23, the article 200 and the marker 210 are placed on a worktable 215. As long as the article 200 is not moved, the positional relationship between the article 200 and the marker 210 remains unchanged. However, an upper part 200a of the article 200 can be rotated with respect to a lower part 200b. The fastening portions 201 to 206 are positioned in the upper part 200a. Therefore, when the upper part 200a rotates with respect to the lower part 200b, the positional relationship between the fastening locations 201 to 206 and the marker 210 changes.

In such a case, as shown in FIG. 23, a marker 211, which has a fixed positional relationship with the fastening locations, is further provided. The processing device 10 detects the marker 211 from the image and sets the three-dimensional coordinate system to display the virtual objects using the marker 211 as the origin. The display positions of the first object 310, the second object 320, etc. are determined using the three-dimensional coordinate system based on the marker 211. Therefore, when the marker 211 moves, the display position of each virtual object also moves. Even when the upper part 200a is rotated with respect to the lower part 200b or when the article 200 moves with respect to the marker 210, each virtual object can be displayed at an appropriate position regardless of the rotation or movement.

If there is a fastening location in the lower part 200b, a virtual object may be displayed for the fastening location. In such a case, the position of the virtual object displayed to the lower part 200b is set using the three-dimensional coordinate system based on the marker 210. Therefore, regardless of the change in the position of the marker 211, the virtual object can be displayed at an appropriate position for the lower part 200b.

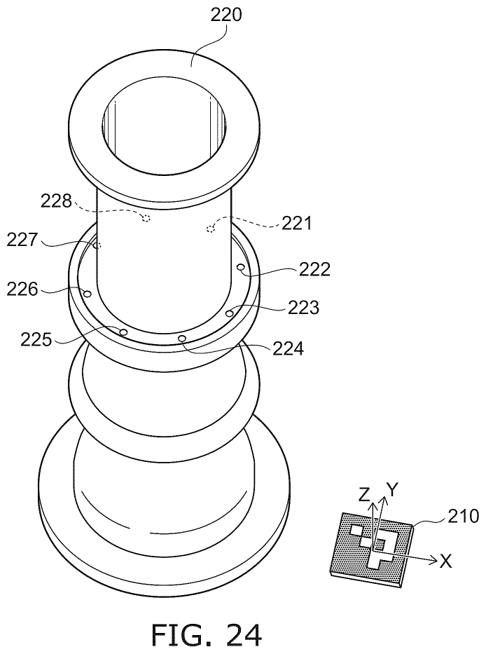

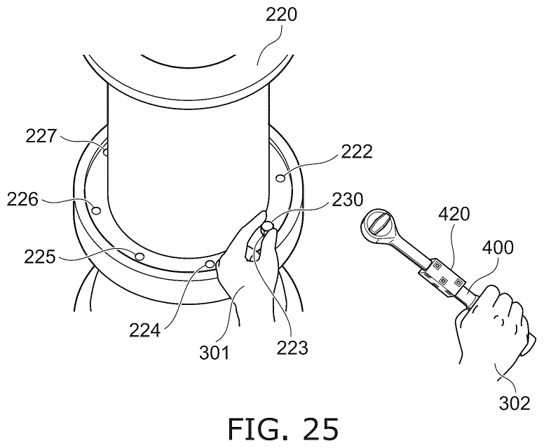

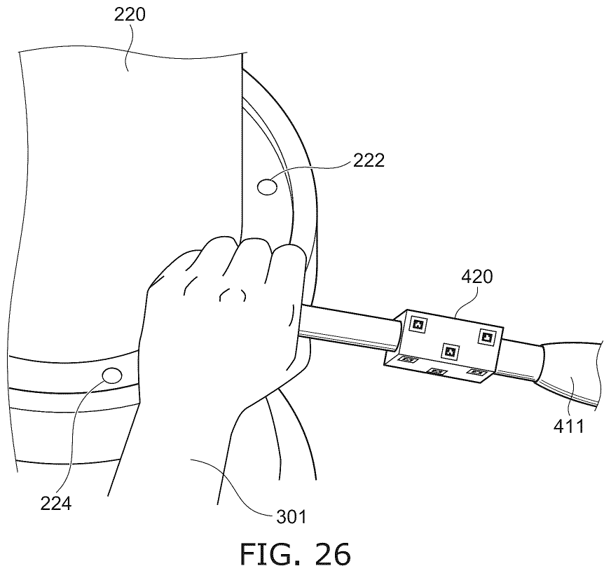

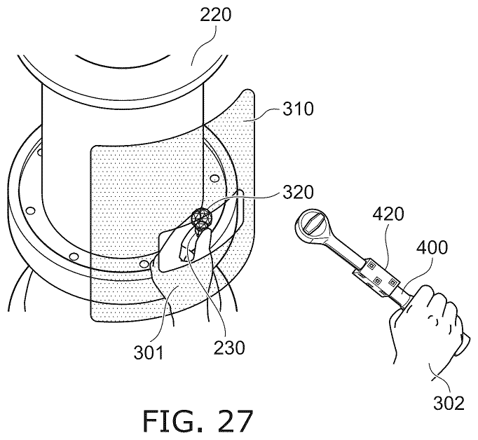

FIG. 24 is a schematic view illustrating a state of the real space. FIGS. 25 and 26 are schematic views illustrating a state of the task. FIG. 27 is a schematic view illustrating a display example by the processing system according to the embodiment.

FIG. 24 is a schematic view illustrating another task object. The fastening task may be performed on the article 220 shown in FIG. 24. The article 220 is cylindrical and multiple fastening locations 221 to 228 exist along the outer circumference of the article 220.

For example, the worker tightens a screw into the fastening location 223. In such a case, the worker places the screw 230 into the screw hole of the fastening location 223 as shown in FIG. 25. Next, the worker holds the grip of the wrench 400 with his right hand. A socket is attached to the wrench 400. The worker fits the tip (head) of the wrench 400 onto the screw 230. Thereafter, the worker rotates the wrench 400 with the right hand 302 while holding the head of the wrench 400 with the left hand 301 as shown in FIG. 26. Thereby, the screw 230 is tightened into the fastening location 223.

During the task shown in FIGS. 25 and 26, for example, the first object 310 and the second object 320 are displayed, as shown in FIG. 27. The first object 310 is displayed around the region where the wrench 400 can be positioned when tightening the screw into the fastening location 223. The second object 320 is displayed at a position close to the fastening location 223. When the processing device 10 detects that the hand has come into contact with the second object 320, the processing device 10 estimates that a screw is tightened into the fastening location 223. During the fastening task, the processing device 10 estimates the position of the wrench 400. The processing device 10 issues an alert when the wrench 400 comes into contact with the first object 310. The processing device 10 does not issue an alert when the hand comes into contact with the first object 310.

In the example shown in FIGS. 24 to 27, multiple regions may be set to the first object 310, as in the example shown in FIG. 10. These regions are set to vary the alerts for each region. Similar to the example shown in FIG. 13, multiple portions may be set for the wrench 400. These portions are set to vary the alerts for each portion.

As shown in FIG. 15A, FIG. 15B, FIG. 22, and FIG. 27, the shape, position, size, etc. of each of the first object 310 and the second object 320 can be appropriately changed according to the tool used in the task, the position of the fastening location, etc.

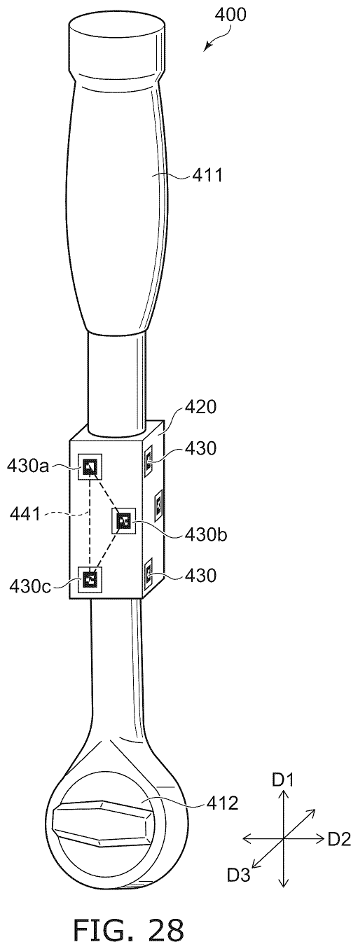

FIG. 28 is a schematic view illustrating the tool.

A preferred example of how to estimate the position of the tool will be described. For example, as shown in FIG. 28, multiple markers 430 are attached to the wrench 400. In the illustrated example, a jig 420 is attached to the wrench 400, and multiple markers 430 are attached to the jig 420. The jig 420 has multiple planes. Three markers 430 are attached to each plane,

For three markers 430 on one plane, the distance between one marker 430 and another marker 430 is different from the distance between the one marker 430 and yet another marker 430. In other words, the three markers 430 are arranged in such a way that, when an imaginary triangle connecting the three markers 430 is generated, the triangle does not become an equilateral triangle.

Preferably, multiple markers 430 are located so that one side of the triangle is parallel to the direction in which the tool is extended. In the example shown in FIG. 28, the wrench 400 extends to a first direction D1. The first direction D1 corresponds to a direction connecting the grip 411 of the wrench 400 and the head 412 of the wrench 400. The imaginary triangle 441 based on the markers 430a to 430c has a side parallel to the first direction D1. Here, the two directions perpendicular to the first direction D1 and perpendicular to each other are taken as a second direction D2 and a third direction D3.

The processing device 10 detects multiple markers 430 from the images acquired by the imaging device 20. The processing device 10 calculates the position of the wrench 400 from the positions of at least three markers 430. The position of part that overlaps with or is close to the virtual object during an appropriate fastening task is used as the position of the wrench 400. For example, the processing device 10 calculates the position of the head 412 from the positions of at least three markers 430. The processing device 10 issues an alert when the head 412 comes into contact with the first object 310.

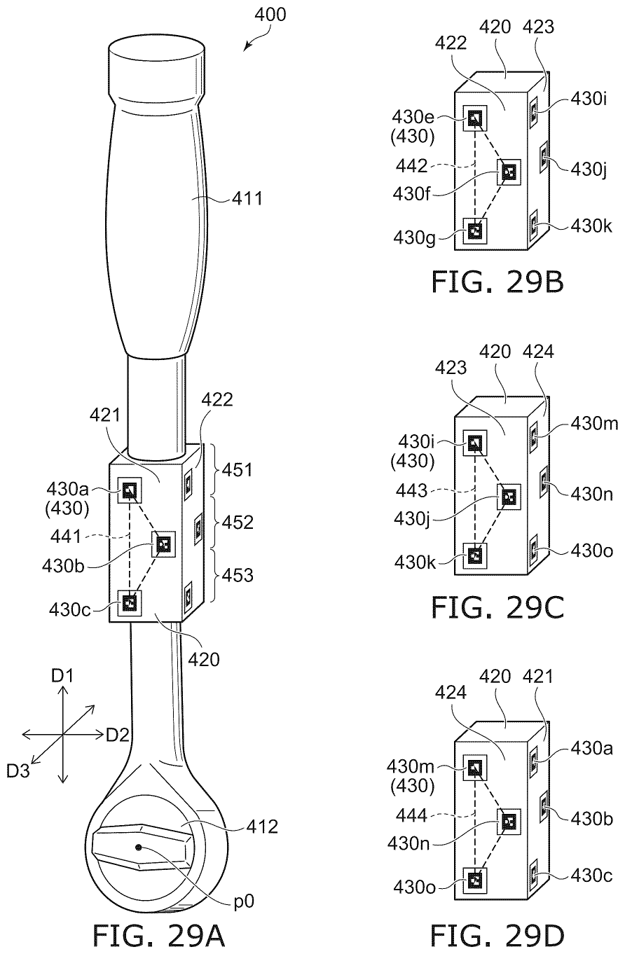

FIG. 29A is a schematic view illustrating an example of the tool. FIGS. 29B to 29D are schematic views illustrating an example of a marker.

A method for calculating the position of the tool will be described more specifically. The ID of the marker 430, the position of the marker 430, the position of the tool calculated by the marker 430, etc. are registered in advance before the fastening task. FIGS. 29A to 29D show the state when the jig 420 is viewed from different directions. The outer shape of the jig 420 is a rectangular parallelepiped, and the jig 420 has four planes 421 to 424. Markers 430a to 430c are affixed to the plane 421. Markers 430e to 430g are affixed to the plane 422. Markers 430i to 430k are affixed to the plane 423. Markers 430m to 4300 are affixed to the plane 424.

The markers 430a to 430c are affixed so that the imaginary triangle 441 obtained by connecting these markers becomes an isosceles triangle. Similarly, the markers 430e to 430g, markers 430i to 430k, and markers 430m to 4300 are respectively affixed so that the imaginary triangles 442 to 444 obtained by connecting multiple markers becomes an isosceles triangle. Each marker is provided at a position where triangles 441 to 444 are rotationally symmetrical to each other with respect to the center of a first plane of the wrench 400. The first plane is a plane that is perpendicular to the first direction D1 in which the wrench 400 extends.

In the preliminary preparation, the ID of each marker 430 and the position of each marker 430 in an arbitrary spatial coordinate system are registered. Further, for each combination of markers 430a to 430c, markers 430e to 430g, markers 430i to 430k, and markers 430m to 4300, a position of part of the wrench 400 is registered. A different position may be registered for each combination of markers, or a common position may be registered for each combination. As an example, for each combination of markers, a position p0 shown in FIG. 29A is registered. The registered position is where the worker's hand holds the tool when the tool is used in the fastening task.

In addition, an attribute related to the position is registered for each marker 430. The attribute indicates where the marker 430 is located within regions 451 to 453. The regions 451 to 453 are arranged in the first direction D1. This attribute is used, as will be described later, to improve the accuracy of estimating the position of the tool during the task.

The IDs of the markers 430, the positions of the markers 430, the position of the tool corresponding to the marker, and the attributes of the positions are association with the ID of the tool; and these data are stored. This completes the preliminary preparation regarding the markers. Hereinafter, the positions of the registered markers and tools in the preliminary preparation are respectively referred to as “the position of the preliminary marker” and “the position of the preliminary tool”.

The processing device 10 detects the marker 430 appearing in the image. When four or more markers 430 are detected, the processing device 10 extracts three markers 430. The processing device 10 calculates the position of the tool from the positions of the three extracted markers 430.

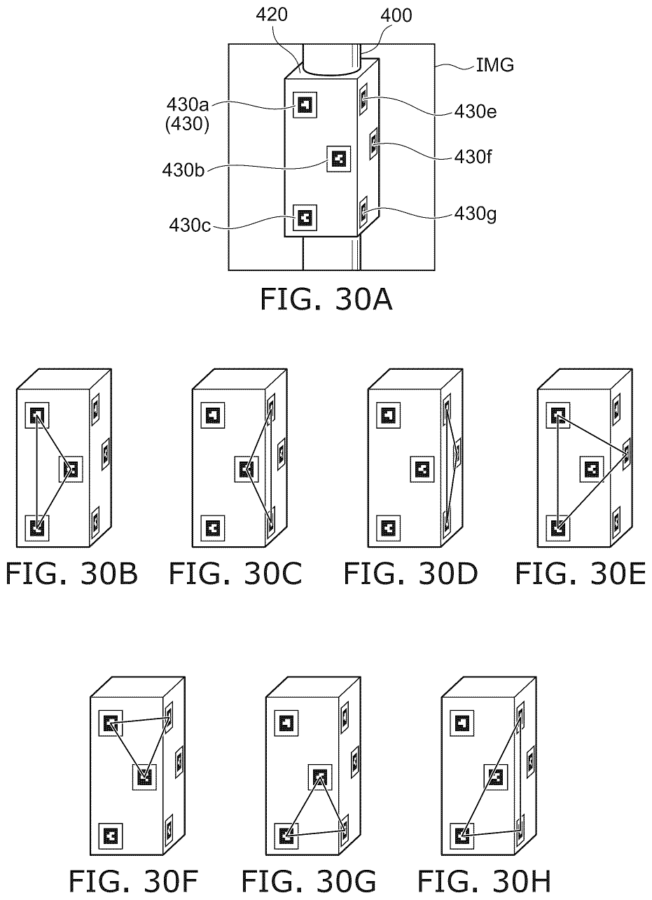

FIGS. 30A to 30H are schematic views for explaining processing in the processing system according to the embodiment.

For example, the imaging device 20 obtains an image IMG shown in FIG. 30A. The image IMG contains markers 430a to 430c and markers 430e to 430g. The processing device 10 extracts a combination of three markers 430 from the markers 430a to 430c and the markers 430e to 430g. The processing device 10 generates a triangle connecting the three markers 430 for each combination. FIGS. 30B to 30H show examples of generated triangles.

Next, the processing device 10 refers to the data of each detected marker 430. As described above, the attribute of the position is registered for each marker 430. The processing device 10 extracts one or more triangles containing markers 430 in each of the regions 451 to 453 from the generated multiple triangles. That is, the processing device 10 extracts one or more triangles with the side along the first direction D1. As a result of the processing, triangles shown in FIG. 30B to FIG. 30E are extracted, while triangles shown in FIG. 30F to FIG. 30H are not extracted.

The processing device 10 calculates a first vector parallel to a normal of the extracted triangle. In addition, the processing device 10 calculates a second vector connecting an observation point (the imaging device 20) and the center point of the triangle. The processing device 10 calculates the angle between the first vector and the second vector. For each of the multiple extracted triangles, the processing device 10 calculates the angle between the first vector and the second vector.

The processing device 10 extracts one triangle with the smallest angle from the multiple extracted triangles. The processing device 10 determines the markers 430 corresponding to the extracted one triangle as markers 430 used to calculate the position of the tool. In the illustrated example, the markers 430a to 430c are determined as markers used to calculate the position of the tool. Hereinafter, the three determined markers may be referred to as “a first marker”, “a second marker”, and “a third marker”.

The processing device 10 measures the position of each of the first to third markers. In addition, the processing device 10 refers to the ID of each of the first to third markers. The processing device 10 acquires the positions of the preliminary first to third markers and the position of the preliminary tool corresponding to the first to third markers. The processing device 10 calculates the position of the tool during the task using each position of the first to third marker obtained during the task, each position of the preliminary first to third markers, and the position of the preliminary tool.

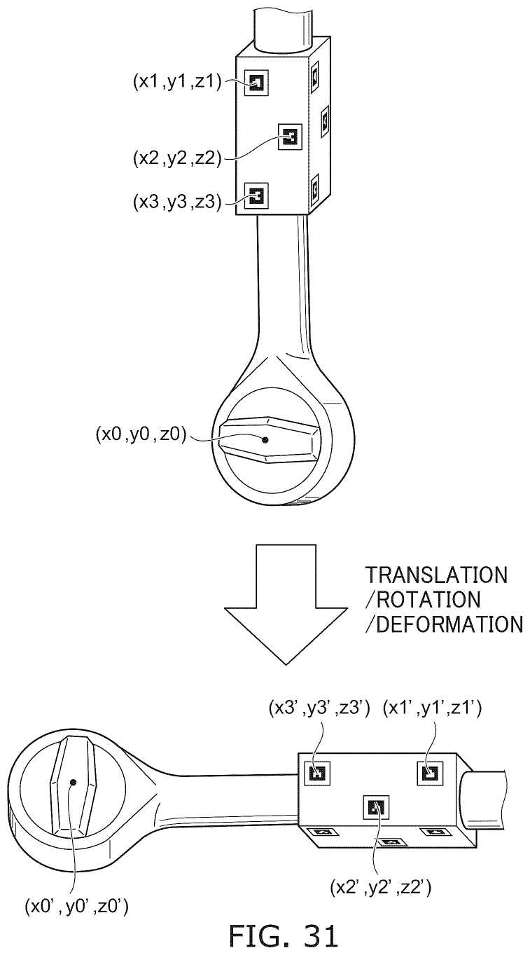

FIG. 31 is a schematic view illustrating the movement of the tool.

Even when the tool is used in the task, the relative position of the tool to the positions of the first to third markers does not change. Here, as shown in FIG. 31, the position of the preliminary first marker is taken as (x1, y1, z1). The position of the preliminary second marker is taken as (x2, y2, z2). The position of the preliminary third marker is taken as (x3, y3, z3). The position of the preliminary tool is taken as (x0, y0, z0). The positions of the first to third markers measured during the task are taken as (x1′, y1′, z1′), (x2′, y2′, z2′), and (x3′, y3′, z3′), respectively. The position of the tool during the task is taken as (x0′, y0′, z0′).

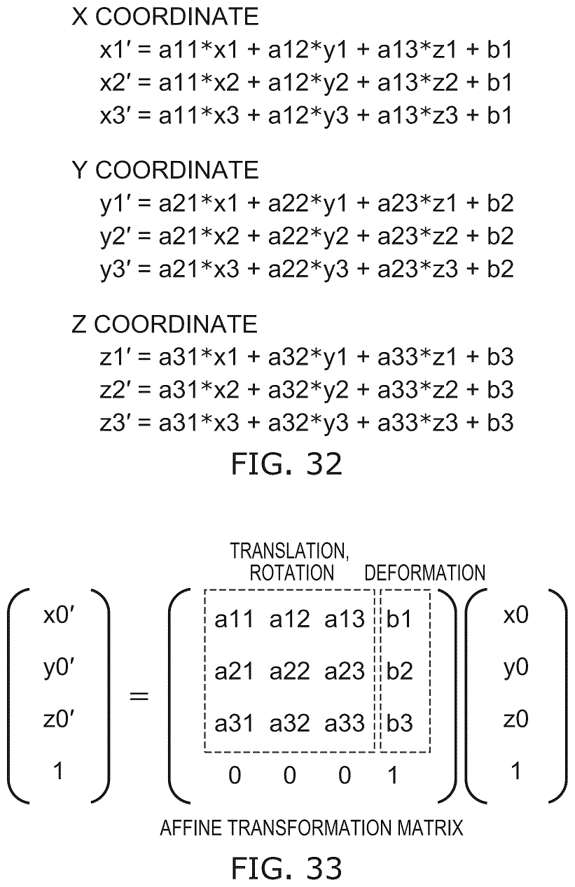

FIG. 32 is simultaneous equations representing the relationship between the position of each marker before movement and the position of each marker after movement.

The relationship between the positions of the preliminary first to third markers and the positions of the first to third markers during the task is represented by the equations of FIG. 32. Each position is substituted into the respective equation shown in FIG. 32 to solve the simultaneous equations. At this time, the coefficients b1 to b3 are set to zero. The coefficients b1 to b3 correspond to the amounts of translation from the positions of the preliminary first to third markers to the positions of the first to third markers during the task. By solving the simultaneous equations, the coefficients a11 to a33 are calculated. The coefficients a11 to a33 indicate the amounts of rotation and deformation from the positions of the preliminary first to third markers to the positions of the first to third markers during the task.

Thereafter, the difference between the position of the midpoint of the preliminary first to third markers and the position of the midpoint of the first to third markers during the task is calculated. The difference in the first direction D1, the difference in the second direction D2, and the difference in the third direction D3 are used as the coefficients b1 to b3, respectively. Note that the spatial coordinate system for registering the positions in the preliminary preparation may be different from the spatial coordinate system used during the task. In such a case, the change in the origin of the spatial coordinate system is also represented as the rotation, deformation, or translation of each marker.

FIG. 33 is a matrix representing the relationship between the position of the tool before movement and the position of the tool after movement.

The processing device 10 uses the coefficients a11 to a33 and the coefficients b1 to b3 as variables of the affine transformation matrix. As shown in FIG. 33, the position of the tool during the task (x0′, y0′, z0′) is calculated by multiplying the affine transformation matrix with the preliminary tool position (x0, y0, z0).

Rotation and translation may be calculated by a method other than the affine transformation matrix. For example, the processing device 10 calculates the difference between the midpoint of the preliminary first to third markers and the midpoint of the first to third markers during the task as a translational distance. The processing device 10 calculates the normal vector of the preliminary first to third markers. Here, the normal vector is referred to as “the preliminary normal vector”. The processing device 10 calculates the normal vector of the first to third markers during the task. Here, the normal vector is referred to as “the current normal vector”. The processing device 10 calculates the direction of rotation and the angle of rotation to align the prior vector with the current vector. By the aforementioned processes, the translation and rotation of the first to third markers are calculated. The processing device 10 calculates the position of the tool during the task by adding the calculated translation and rotation to the position of the tool registered in advance.

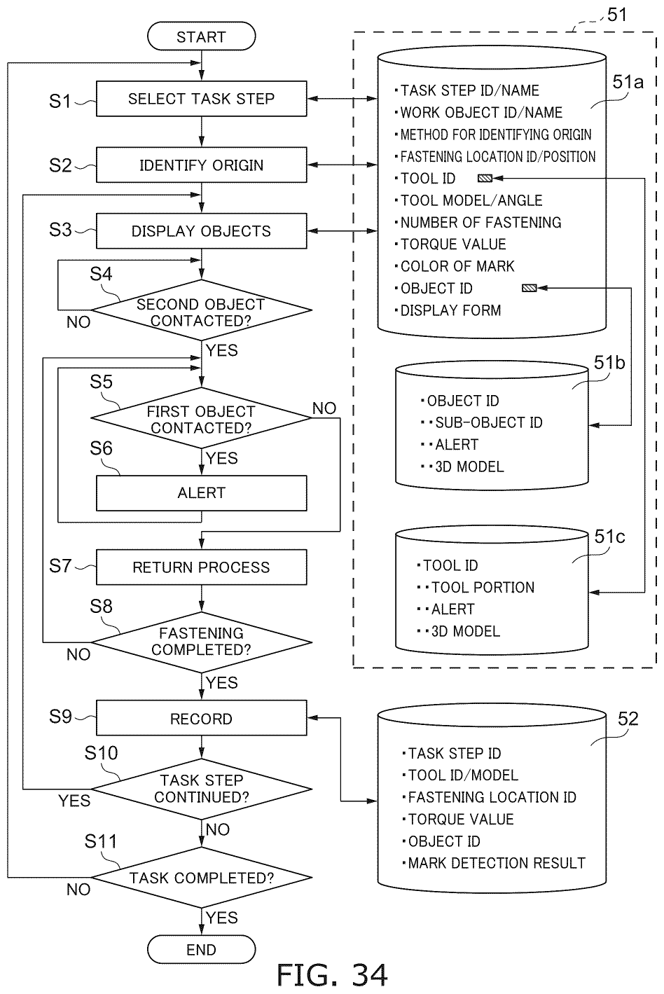

FIG. 34 is a flowchart illustrating a processing method according to the embodiment.

In the processing method according to the embodiment, master data 51 is referred and history data 52 is generated. The master data 51 and the history data 52 are stored in a storage device 50. The master data 51 includes a task master 51a, an object master 51b, and a tool master 51c. The master data 51 is prepared in advance before the screw-tightening.

First, the processing device 10 accepts a selection of a task step (step S1). For example, when an article is manufactured, multiple steps are performed. One step consists of one or more task steps. In each task step, the fastening task may be performed. The task step is selected by the worker. The task to be performed may be instructed by higher-level system, and the processing device 10 may accept a selection according to the instruction. Based on the data obtained from the imaging device 20 or other sensors, the processing device 10 determines the task to be performed next, and the processing device 10 may accept the selection based on the determination. When a task step is selected, the processing device 10 refers to the task master 51a.

The task master 51a mainly contains data related to the task steps, data related to the fastening task, and data related to the virtual objects. As data related to the task steps, the ID of each task step, the name of each task step, the ID of the object to be worked on in each task step, the name of the object, and the method for specifying the origin are registered. As data related to the fastening task, the ID and position of each fastening location, the ID of the tool used in the task, the model and angle of the tool, the number of tightening at each fastening location, the torque value required for each fastening location, and a color of a mark are registered. The tool model indicates the classification of the tool by structure, appearance, performance, etc. The angle indicates an angle of the tool when tightening the screw into each fastening location. The mark is a marker that is attached to the screw when the fastening is completed. As data related to the object, the ID of the virtual object displayed in the task step and the display mode of the virtual object are registered.

The object master 51b contains the ID for each virtual object, the ID of the sub-object (region) set for each virtual object, the alert intensity for each sub-object, and the 3D model (shape, size) of each sub-object.

The tool master 51c contains the ID of each tool, the portions set for each tool, the alert for each portion, and the 3D model (shape, size) of the tool. When the position of the tool is estimated, a virtual tool is generated at the estimated position based on the registered 3D model. Thereafter, the contact between the tool and the first object is determined.

In the task master 51a, data related to the fastening task and data related to the virtual object are associated for each task step. When a task step is selected, the processing device 10 acquires data such as the ID and position of the fastening location and the displayed virtual object for the selected task step.

Next, the processing device 10 identifies the origin in the task step (step S2). The three-dimensional coordinate system is set according to the identified origin. The processing device 10 displays virtual objects including the first object and the second object in the set three-dimensional coordinate system (step S3). The positions at which the first and second objects are displayed are determined based on the position of the fastening location, the model of the tool, the angle of the tool, etc. For example, based on the position of the fastening location, the model of the tool, and the angle of the tool, the region in which the tool may be located during the fastening task is calculated. The first object is displayed around the region. In addition, at the set angle of the tool, a position that is a distance equivalent to the length based on the model of tool away from the fastening location is calculated. The second object is displayed at the calculated position. When a position away from the edge of the tool is held, a position may be calculated, at the set angle, which is a predetermined proportion of the tool's length away from the fastening point. The second object may be displayed at the calculated position.

The processing device 10 repeats the determination whether the prescribed physical object has come into contact with the second object (step S4). When the prescribed physical object comes into contact with the second object, it is estimated that a screw is tightened into the fastening location corresponding to the second object. When the digital tool is used, the detection value by the digital tool is associated with the data related to the estimated location.

When it is determined that the object has come into contact with the second object, the processing device 10 determines whether the tool has come into contact with the first object (step S5). When it is determined that the tool has come into contact with the first object, the processing device 10 issues an alert (step S6). At this time, the second object may be hidden. If the detection value is associated with the data of the estimated location, the data is disassociated.

When it is determined that the tool is not in contact with the first object, the processing device 10 performs a return process (step S7). In the return process, the processing device 10 stops the alert when the alert is issued. If the second object is not displayed, the second object is displayed again. If the data of the estimated location is disassociated with the detection value, the data is associated again.

The processing device 10 determines whether the fastening is completed (step S8). For example, when the torque value detected by the digital tool exceeds the preset value, it is determined that the fastening is completed. Data indicating that the fastening has been completed may be entered by the worker. The determination whether or not the tool comes into contact with the first object is repeated until the fastening is completed.

When it is determined that the fastening is completed, the processing device 10 associates the detection value with the data related to the estimated location, and records the data in the history data 52 (step S9). In the illustrated example, the fastening location ID is recorded as data related to the fastening location. In addition, the task step ID, the tool ID, the tool model, and the object ID displayed in the task step are stored in association with the fastening location ID.

A mark indicating the completion of the task may be attached to the tightened screw. When the screw-tightening is completed, the worker marks the screw or its vicinity. The screw-tightening tool may automatically mark when the task has been completed. The processing device 10 may detect the mark from the image. When the screw-tightening is determined to be completed, the processing device 10 refers to the color of the mark used for the screw-tightening. The processing device 10 counts the number of pixels of the mark's color in the image obtained by the imaging device 20. The processing device 10 determines whether the number of pixels exceeds a preset threshold value. When the number of pixels exceeds the threshold value, the processing device 10 determines that the screw has been marked. In the illustrated example, the detection result indicating that the mark has been detected is further associated with the fastening location ID.

The processing device 10 determines whether the task step selected in step S1 is continued (step S10). If the task step is continued, the display of the virtual objects by step S3 is continued. When the task step is completed, the processing device 10 determines whether all the task has been completed (step S11). If all the task is not completed, the step S1 is performed again and the next task step is selected.

In the example described above, an example in which a screw is tightened into a fastening location has been mainly described. Embodiments of the present invention are applicable not only when a screw is tightened into the fastening location, but also when the screw in the fastening location is loosened. For example, when maintaining, inspecting, or repairing a product, the screws in the fastening locations are loosened. According to the embodiment of the present invention, when loosening the screw, the worker can be notified that the tool is being used in an inappropriate orientation or that the screw in the wrong location is being loosened. Therefore, it is possible to encourage the worker to perform the task more appropriately. For example, the possibility of damaging an article or injuring a worker by using the tool in inappropriate orientation can be reduced. And, it is possible to reduce the possibility that the worker loosen a screw in a wrong fastening location.

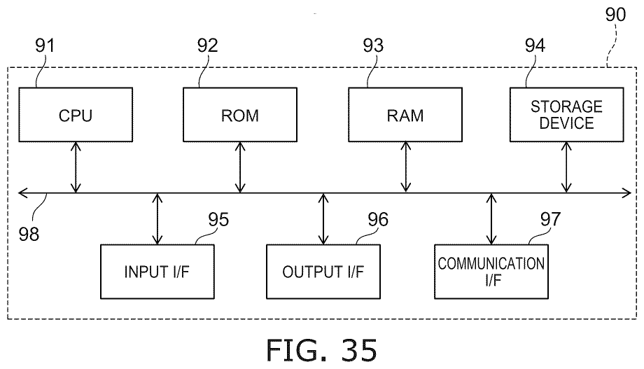

FIG. 35 is a schematic diagram illustrating a hardware configuration.

For example, a computer 90 shown in FIG. 35 is used as the processing device 10 or the processing device 150. The computer 90 includes a CPU 91, ROM 92, RAM 93, a storage device 94, an input interface 95, an output interface 96, and a communication interface 97.

The ROM 92 stores programs that control the operations of the computer 90. Programs that are necessary for causing the computer 90 to realize the processing described above are stored in the ROM 92. The RAM 93 functions as a memory region into which the programs stored in the ROM 92 are loaded.

The CPU 91 includes a processing circuit. The CPU 91 uses the RAM 93 as work memory to execute the programs stored in at least one of the ROM 92 or the storage device 94. When executing the programs, the CPU 91 executes various processing by controlling configurations via a system bus 98.

The storage device 94 stores data necessary for executing the programs and/or data obtained by executing the programs. The storage device 94 includes a solid state drive (SSD), etc. The storage device 94 may be used as the storage device 50 or the storage device 170.

The input interface (I/F) 95 can connect the computer 90 to the input device 40. The CPU 91 can read various data from the input device 40 via the input I/F 95.

The output interface (I/F) 96 can connect the computer 90 and an output device. The CPU 91 can transmit data to the display device 30 via the output I/F 96 and can cause the display device 30 to display information.

The communication interface (I/F) 97 can connect the computer 90 and a device outside the computer 90. For example, the communication I/F 97 connects the digital tool and the computer 90 by Bluetooth (registered trademark) communication.

The data processing of the processing device 10 or the processing device 150 may be performed by only one computer 90. A portion of the data processing may be performed by a server or the like via the communication I/F 97.

The processing of the various data described above may be recorded, as a program that can be executed by a computer, in a magnetic disk (a flexible disk, a hard disk, etc.), an optical disk (CD-ROM, CD-R, CD-RW, DVD-ROM, DVD-R, DVD-RW, etc.), semiconductor memory, or another non-transitory computer-readable storage medium.

For example, the information that is recorded in the recording medium can be read by the computer (or an embedded system). The recording format (the storage format) of the recording medium is arbitrary. For example, the computer reads the program from the recording medium and causes a CPU to execute the instructions recited in the program based on the program. In the computer, the acquisition (or the reading) of the program may be performed via a network.

Furthermore, the processing system 1 may be implemented as another device other than the MR device. For example, the processing system 1 may be implemented using a general-purpose PC. In such a case, a monitor can be used as the display device 30. An input device 40 such as a keyboard, a microphone, or a touchpad can be used. The imaging device 20 may be positioned away from the user to image the user's actions. The user input commands to the processing device 10 using the input device 40 while referencing the display device 30.

The embodiment of the invention includes following features.

### Feature 1

A processing system used for a task of turning a screw at a fastening location with a tool, the processing system comprising:
a display device configured to display a virtual first object around a region where the tool can be positioned during the task; and
a processing device configured to estimate a position of the tool, the processing device being configured to issue an alert in a case where the tool is determined to be in contact with the first object based on the estimated position.

### Feature 2

The processing system according to feature 1, further comprising an imaging device being configured to image the tool,
in a case where a marker present in a real space is imaged by the imaging device, the processing device determines a display position of the first object based on the marker.

### Feature 3

The processing system according to feature 2, wherein
the marker is provided on an article including the fastening location, and
the processing device is configured to change the display position of the first object according to a movement of the article or the marker.

### Feature 4

The processing system according to any one of features 1 to 3, wherein
the display device is configured to display a virtual second object at a different position from the first object, and
the processing device is configured to estimate that a screw is tightened into the fastening location corresponding to the second object in a case where a prescribed physical object contacts the second object and the tool does not contact the first object.

### Feature 5

The processing system according to feature 4, wherein
the processing device is configured to receive a detection value detected by the tool and associates the detection value with data related to the corresponding fastening location.

### Feature 6

The processing system according to feature 4 or 5, wherein
in a case where the tool comes into contact with the first object, the display device does not display the second object, and
in a case where the tool no longer contact the first object after contacting the first object, the display device displays the second object.

### Feature 7

The processing system according to any one of features 4 to 6, wherein
the display device is configured to display a plurality of the second objects respectively corresponding to a plurality of the fastening locations, and
display modes of the plurality of second objects are different from each other depending on a fastening order of the plurality of fastening locations or whether or not each of the plurality of fastening locations has been tightened.

### Feature 8

The processing system according to any one of features 1 to 7, wherein
the first object includes a first region and a second region, the second region being positioned between the first region and the fastening location, and
the processing device is configured to differentiate an alert issued when the tool comes into contact with the first region from an alert issued when the tool comes into contact with the second region.

### Feature 9

The processing system according to any one of features 1 to 8, wherein
the display device is configured to display a virtual third object indicating an instruction related to the task.

### Feature 10

The processing system according to any one of features 1 to 9, wherein
the processing device is configured to read master data, the master data containing a position of the fastening location, a number of times the screw is tightened into the fastening location, the tool used in the task, and an virtual object displayed in the task, and
   the first object is displayed based on the master data.

### Feature 11

The processing system according to any one of features 1 to 10, wherein
the processing device is configured to estimate the position of the tool using at least one selected from a marker attached to the tool, a sensor attached to the tool, and image processing of an image of the tool.

### Feature 12

A mixed reality device, the mixed reality device is configured to:
image a task of turning a screw at a fastening location with a tool;
display a virtual first object around a region where the tool can be positioned during the task; and
issue an alert in a case where the tool comes into contact with the first object.

### Feature 13

A processing method executed by a computer, comprising:
acquiring an image of a task of turning a screw at a fastening location with a tool;
causing a display device to display a virtual first object around a region where the tool can be positioned during the task;
estimate a position of the tool from the image, and issue an alert in a case where the tool is determined to be in contact with the first object based on the estimated position.

### Feature 14

A non-transitory computer-readable storage medium storing a program, the program causing the computer to execute the processing method according to feature 13.

According to the embodiments described above, a processing system, a mixed reality device, a processing method, program, and a storage medium are provided, which can encourage a worker to perform a task more appropriately.

In the specification, “or” shows that “at least one” of items listed in the sentence can be adopted.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the invention. Moreover, above-mentioned embodiments can be combined mutually and can be carried out.

What is claimed is:

1. A processing system used for a task of turning a screw at a fastening location with a tool, the processing system comprising:
a display device configured to display a virtual first object around a region where the tool can be positioned during the task; and
a processing device configured to estimate a position of the tool, the processing device being configured to issue an alert in a case where the tool is determined to be in contact with the first object based on the estimated position.

2. The processing system according to claim 1, further comprising an imaging device being configured to image the tool,
in a case where a marker present in a real space is imaged by the imaging device, the processing device determines a display position of the first object based on the marker.

3. The processing system according to claim 2, wherein
the marker is provided on an article including the fastening location, and
the processing device is configured to change the display position of the first object according to a movement of the article or the marker.

4. The processing system according to claim 1, wherein
the display device is configured to display a virtual second object at a different position from the first object, and
the processing device is configured to estimate that a screw is tightened into the fastening location corresponding to the second object in a case where a prescribed physical object contacts the second object and the tool does not contact the first object.

5. The processing system according to claim 4, wherein
the processing device is configured to receive a detection value detected by the tool and associates the detection value with data related to the corresponding fastening location.

6. The processing system according to claim 4, wherein
in a case where the tool comes into contact with the first object, the display device does not display the second object, and
in a case where the tool no longer contact the first object after contacting the first object, the display device displays the second object.

7. The processing system according to claim 4, wherein
the display device is configured to display a plurality of the second objects respectively corresponding to a plurality of the fastening locations, and
display modes of the plurality of second objects are different from each other depending on a fastening order of the plurality of fastening locations or whether or not each of the plurality of fastening locations has been tightened.

8. The processing system according to claim 1, wherein
the first object includes a first region and a second region, the second region being positioned between the first region and the fastening location, and
the processing device is configured to differentiate an alert issued when the tool comes into contact with the first region from an alert issued when the tool comes into contact with the second region.

9. The processing system according to claim 1, wherein
the display device is configured to display a virtual third object indicating an instruction related to the task.

10. The processing system according to claim 1, wherein
the processing device is configured to read master data, the master data containing a position of the fastening location, a number of times the screw is tightened into the fastening location, the tool used in the task, and a virtual object displayed in the task, and the first object is displayed based on the master data.

11. The processing system according to claim 1, wherein
the processing device is configured to estimate the position of the tool using at least one selected from a marker attached to the tool, a sensor attached to the tool, and image processing of an image of the tool.

12. A mixed reality device, the mixed reality device is configured to:
image a task of turning a screw at a fastening location with a tool;
display a virtual first object around a region where the tool can be positioned during the task; and
issue an alert in a case where the tool comes into contact with the first object.

13. A processing method executed by a computer, comprising:
acquiring an image of a task of turning a screw at a fastening location with a tool;
causing a display device to display a virtual first object around a region where the tool can be positioned during the task;
estimate a position of the tool from the image, and issue an alert in a case where the tool is determined to be in contact with the first object based on the estimated position.

14. A non-transitory computer-readable storage medium storing a program, the program causing the computer to execute the processing method according to claim 13.
